(19) United States
(12) Patent Application Publication
(10) Pub. No.: US 2021/0234250 A1
(43) Pub. Date: Jul. 29, 2021

(54) Antenna with Built-in Heatsink Structure

(71) Applicant: Veea Inc., New York, NY (US)

(72) Inventors: Bob Migliorino, Wayne, NJ (US); Michael Liccone, Scotch Plains, NJ (US); Shaun Greaney, Freehold, NJ (US); Dave Doyle, New York, NY (US); Michael Mirabella, New York, NY (US); Perry Wintner, New York, NY (US); Theodore Lubbe, New York, NY (US); Clint Smith, New York, NY (US)

(21) Appl. No.: 17/153,942

(22) Filed: Jan. 21, 2021

Related U.S. Application Data
(60) Provisional application No. 62/965,672, filed on Jan. 24, 2020.

(51) Int. Cl. H01Q 1/02; H01Q 21/00; H01Q 9/28

(52) U.S. Cl. CPC H01Q 1/02; H01Q 9/285; H01Q 21/0025

(57) ABSTRACT

An antenna system with a build in heatsink for use in a modular wireless communications system. The antenna system may include a ground plane component and an antenna component. The antenna component may include a radiating portion for broadcasting wireless communications signals, a grounded end affixable to the ground plane component, and a shorted portion positioned between the radiating portion and the grounded end.

### RELATED APPLICATIONS

This application claims the benefit of priority to U.S. Provisional Application No. 62/965,672, entitled “Antenna with Built-in Heatsink Structure” filed Jan. 24, 2020, the entire contents of which are hereby incorporated by reference for all purposes.

### BACKGROUND

Wireless communication technologies have been growing in popularity and use over the past several years. This growth has been fueled by better communications hardware, larger networks, and more reliable protocols. Wireless and Internet service providers are now able to offer their customers with an ever-expanding array of features and services, such as robust cloud-based services.

To better support these enhancements, more powerful consumer facing edge devices (e.g., consumer grade access points, IoT gateways, routers, switches, etc.) are beginning to emerge. These devices include more powerful processors, system-on-chips (SoCs), memories, antennas, power amplifiers, and other resources (e.g., power rails, etc.) that better support high-speed wireless communications and execute complex and power intensive applications facilitating edge computing.

In addition to high performance and functionality, consumers increasingly demand that their devices be affordable, future-proof (e.g., upgradeable, highly versatile, etc.) and small enough to readily placed throughout a home or small office.

### SUMMARY

The various aspects include antenna system for use in a modular wireless communications system. In some aspects, the antenna system may include a ground plane component and an antenna component. In some aspects, the antenna component may include a radiating portion for broadcasting wireless communications signals, a grounded end affixable to the ground plane component, and a shorted portion positioned between the radiating portion and the grounded end.

In some aspects, the antenna system may include an integrated cable structure that includes a conductive element, and a sheathing element that includes a nonconductive tubing surrounded by a conductive shielding, and in which the conductive element is positionable within the nonconductive tubing to be electrically isolated from the conductive shielding.

In some aspects, the ground plane component may include an aperture through which an elongated side of integrated cable structure is inserted. In some aspects, the size of aperture of the ground plane component may be sufficiently large to allow heat or hot air to rise through the aperture alongside the inserted integrated cable structure. In some aspects, the first end of the conductive element is affixable to a tuning point of the antenna component, the tuning point being positionable between the radiating portion and the shorted portion, and a second end of the conductive element is affixable to a radio frequency (RF) transceiver.

In some aspects, the conductive element is useable to send and receive wireless communications between the radiating portion and the RF transceiver, in which the RF transceiver is in electric communication with a computing device configurable to process RF data. In some aspects, the tuning point is determinable based on a desired impedance value of the antenna component that is defined by the distance between the radiating portion and the ground plane component. In some aspects, the conductive shielding of the sheathing element is affixable to the ground plane component. In some aspects, the integrated cable structure is a coaxial cable.

In some aspects, the antenna component is a planar inverted F-antenna (PIFA). In some aspects, the radiating portion, the shorted portion, and the grounded end are formable from a single piece of material. In some aspects, the grounded end is affixed along a surface of the ground plane component to provide structural support sufficient to keep the radiating portion stationary. In some aspects, the antenna component is operable to dissipate heat transferred from the ground plane component.

In some aspects, the modular wireless communications system may include the antenna system and a heatsink base including a frame structure and a plurality of fin components projecting outwardly from the frame structure, in which a portion of the plurality of fin components are configured to receive and hold the antenna system. In some aspects, the antenna system may be oriented with respect to the plurality of fin components, such that a first direction of airflow travelling between the plurality of fin components is the same or substantially the same as a second direction of airflow travelling around the antenna system. In some aspects, operating parameters of the antenna component may be based at least in part on a parasitic capacitance value between the radiating portion and the plurality of fin components, in which the parasitic capacitance value is based at least in part on the distance between the radiating portion and the plurality of fin components.

Further aspects may include a wireless modular communications system that includes an antenna system including a ground plane component and an antenna component including a radiating portion for broadcasting wireless communications signals, a grounded end affixable to the ground plane component, and a shorted portion positioned between the radiating portion and the grounded end, and an integrated cable structure including a conductive element, and a sheathing element including a nonconductive tubing surrounded by a conductive shielding, in which the conductive element is positionable within the nonconductive tubing to be electrically isolated from the conductive shielding, in which the integrated cable structure is insertable into an aperture of the ground plane component, and in which a first end of the conductive element is affixable to a tuning point of the antenna component, the tuning point being positionable between the radiating portion and the shorted portion, and a second end of the conductive element is affixable to a radio frequency (RF) transceiver, and a heatsink base including a frame structure, and a plurality of fin components projecting outwardly from the frame structure, in which a portion of the plurality of fin components are configured to receive and hold the antenna system.

Further aspects may include a computing device (e.g., edge device, ect.) that includes any or all the antenna systems and/or wireless modular communications systems described above. Further aspects may include methods for forming, manufacturing or operating any or all the antenna systems and/or wireless modular communications systems described above.

### BRIEF DESCRIPTION OF THE DRAWINGS

The accompanying drawings, which are incorporated herein and constitute part of this specification, illustrate exemplary aspects of the claims, and together with the general description given above and the detailed description given below, serve to explain the features of the claims.

FIG. 1A is a schematic isometric view of an integrated heatsink and antenna structure in accordance with various embodiments.

FIG. 1B is a front elevation view of the integrated heatsink and antenna structure of FIG. 1A in accordance with various embodiments.

FIGS. 2A-C are isometric, top, and side views, respectively of an integrated heatsink and antenna structure that include multiple radio frequency (RF) antennas with corresponding heat sink portions in accordance with some embodiments.

FIG. 3 is a partially exploded isometric view of the integrated heatsink and antenna structure of FIG. 2A.

FIG. 4 is an isolated top view of a heatsink base component in accordance with various embodiments.

FIGS. 5A and 5B are exploded and assembled isometric views, respectively, of stackable housings for integrated heatsink and antenna structures in accordance with various embodiments.

FIGS. 6A and 6B are component block diagrams illustrating a computing system that includes an expandable architecture and a stack connector in accordance with some embodiments.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, the embodiments include an integrated antenna system for use in a modular wireless communications system, such as an edge device (e.g., Wi-Fi access points, IoT gateways, etc.) that includes a baseline feature set and an expandable architecture that allows end users to add specific features or functionality (e.g., digital concierge, home assistant, etc.) to the device as needed. The modular wireless communications system and its components may be configured, shaped, formed or arranged so that the customer or user can quickly physically attach additional units (e.g., an auxiliary unit, another base unit, etc.) above, below, or to the sides of a base unit. Once attached, the combined unit (i.e., the base unit and the attached additional units) may operate as a single unified device.

In some embodiments, the wireless modular communications system may include the integrated antenna system with a heatsink base. The heatsink base may include a frame structure and a plurality of fin components projecting outwardly from the frame structure. All or portions of any or all of the fin components may be shaped, arraigned, or configured to receive and hold the integrated antenna system. In some embodiments, the integrated antenna system may be oriented, with respect to the plurality of fin components, such that a first direction of airflow travelling between the plurality of fin components is the same or substantially the same as a second direction of airflow travelling around the integrated antenna system.

The integrated antenna system may include a ground plane component, an antenna component (e.g., a planar inverted F-antenna (PIFA) component, etc.), and/or an integrated cable structure (e.g., an integrated coaxial cable structure, etc.). In some embodiments, the ground plane component may include a sufficiently large aperture through which a cable (e.g., a coaxial cable, etc.) or the integrated cable structure may be inserted and/or to adequately allow sufficient heat to rise through the aperture.

In some embodiments, the antenna component may include a radiating portion configured to broadcast wireless communications signals, a grounded end affixed to the ground plane component of the integrated antenna system, a shorted portion that is positioned between the radiating portion and the grounded end, and/or a tuning point between the radiating portion and the shorted portion. In some embodiments, the operating parameters of the antenna component may be based, at least in part, on a parasitic capacitance value between the radiating portion and at least one or more of the plurality of fin components. In some embodiments, the parasitic capacitance value may be based, at least in part, on the distance between the radiating portion and at least one or more of the plurality of fin components.

In some embodiments, the grounded end of the antenna component may be affixed along a surface of the ground plane component of the integrated antenna system so as to provide sufficient structural support to keep the radiating portion of the antenna component stationary. In some embodiments, the radiating portion, the shorted portion, and the grounded end of the antenna component may be formed from a single piece of material (e.g., aluminum, copper, gold, etc.). In some embodiments, the antenna component may be operable to dissipate heat, such as heat transferred from the ground plane component during operation of the wireless modular communications system.

In some embodiments, the integrated cable structure may include a conductive element and a sheathing element. The sheathing element may include a nonconductive tubing surrounded by a conductive shielding that is affixed to the ground plane component of the integrated antenna system. The conductive element may be positioned within the nonconductive tubing of the sheathing element such that the conductive element is electrically isolated from the conductive shielding of the sheathing element. In some embodiments, one end of the conductive element may be affixed to the tuning point of the antenna component, and another end of the conductive element may be affixed to a radio frequency (RF) transceiver. In some embodiments, the conductive element may be configured to send and receive wireless communications between the radiating portion and the RF transceiver, which may be electronically coupled to (or in electric communication with) a processor or computing device configured to process RF data and communications.

The features, configurations, properties of the integrated antenna system discuss above and throughout this application allow the wireless modular communications system to be formed such that its RF antenna portions operate to improve the thermal performance of its heatsink base and/or so that its heatsink base operates to improve its antenna properties (e.g., radiation patterns, radiation efficiency, bandwidth, input impedance, polarization, directivity, gain, beam-width, voltage standing wave ratio, etc.). These improvements in thermal performance and/or antenna properties may allow device manufacturers to build more powerful small and midsized devices that provide robust functionality (e.g., via additional antennas, more powerful processors that generate more heat, etc.) and which may be formed into more visually appealing shapes. These improvements may also allow device manufacturers to build or form the devices into smaller shapes that allow a customer or user to quickly stack or physically attach the device to other devices to create a combined unit that operate as a much more powerful or feature-rich device.

The various embodiments may include, use, incorporate, implement, provide access to a variety of wired and wireless communication networks, technologies and standards that are currently available or contemplated in the future, including any or all of Bluetooth®, Bluetooth Low Energy, ZigBee, LoRa, Wireless HART, Weightless P, DASH7, RPMA, RFID, NFC, LwM2M, Adaptive Network Topology (ANT), Worldwide Interoperability for Microwave Access (WiMAX), WIFI, WiFi6,WIFI Protected Access I & II (WPA, WPA2), personal area networks (PAN), local area networks (LAN), metropolitan area networks (MAN), wide area networks (WAN), networks that implement the data over cable service interface specification (DOCSIS), networks that utilize asymmetric digital subscriber line (ADSL) technologies, third generation partnership project (3GPP), long term evolution (LTE) systems, LTE-Direct, third generation wireless mobile communication technology (3G), fourth generation wireless mobile communication technology (4G), fifth generation wireless mobile communication technology (5G), global system for mobile communications (GSM), universal mobile telecommunications system (UMTS), high-speed downlink packet access (HSDPA), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-136/TDMA), evolution-data optimized (EV-DO), digital enhanced cordless telecommunications (DECT), etc. Each of these wired and wireless technologies involves, for example, the transmission and reception of data, signaling and/or content messages.

Any references to terminology and/or technical details related to an individual wired or wireless communications standard or technology are for illustrative purposes only, and not intended to limit the scope of the claims to a particular communication system or technology unless specifically recited in the claim language.

The term “computing device” may be used herein to refer to any one or all of quantum computing devices, edge devices, Internet access gateways, modems, routers, network switches, residential gateways, access points, integrated access devices (IAD), mobile convergence products, networking adapters, multiplexers, personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., smartwatch, head-mounted display, fitness tracker, etc.), IoT devices (e.g., smart televisions, smart speakers, smart locks, lighting systems, smart switches, smart plugs, smart doorbells, smart doorbell cameras, smart air pollution/quality monitors, smart smoke alarms, security systems, smart thermostats, etc.), media players (e.g., DVD players, ROKU™, AppleTV™, etc.), digital video recorders (DVRs), and other similar devices that include a programmable processor and communications circuitry for providing the functionality described herein.

The term “quantum computing device” may be used herein to refer to a computing device or edge device, whether it is a standalone device or used in conjunction with current computing processes, that generates or manipulates quantum bits (qubits) or which utilizes quantum memory states. A quantum computing device may enhance edge computing capability by providing solutions that would be challenging to implement via conventional computing systems. This is especially true with value added computing for leveraging a diverse amount of sensors and other input data to arrive at a solution in real time. Through unifying diverse data sources a quantum computing solution at the edge may accelerate machine learning, solve complex problems faster as well as provide the fundamental platform for artificial intelligence nodes at the edge of the network. With the vast array of data delivered by sensors as well state information the quantum computing process may improve the memory allocation though the use of superposition allowing for more information to be simultaneously stored and processed.

The term “edge device” may be used herein to refer to a computing device that includes a programmable processor and communications circuitry for establishing communication links to consumer devices (e.g., smartphones, UEs, IoT devices, etc.) and/or to network components in a service provider, core, cloud, or enterprise network. For example, an edge device may include or implement functionality associated any one or all of an access point, gateway, modem, router, network switch, residential gateway, mobile convergence product, networking adapter, customer premise device, multiplexer and/or other similar devices.

Various different types of antennas are available or contemplated in the future. To focus the discussion on the most important details, some embodiments are described with reference to planar inverted-F antennas. However, nothing in this application should be use to limit the scope of the claims to a specific type antenna unless expressly recited as such in the claims.

Generally, components and circuitry within a computing device (e.g., wireless access point, router, edge device, router, etc.) generate heat or thermal energy, which at excessive levels could have a significant negative impact on the performance and functioning of the computing device. The amount of thermal energy that is generated may depend upon the components included in the computing device, operating conditions, and/or the operations or activities in the computing device. For example, a computing device that wirelessly transmits data for a sustained time period at a high power-level may require that a power amplifier feed the antenna. The power amplifier may generate a significant amount of thermal energy that could have a negative impact on the performance of the computing device. As another example, processors and other components in the computing device generate a significant amount thermal energy when the performing complex tasks, such as video processing, cryptography, or machine learning. The thermal energy generated by these processors/components could have a significant negative impact on the performance and functioning of the computing device.

Many modern computing systems are equipped with heat dissipating structures that help ensure the device does not operate at unsafe temperatures that damage or shorten the operating life of the device. Modern computing systems are often also equipped with radiating structures (antennas) for sending and receiving wireless communications.

In many conventional systems, the heat dissipating structures are separate and independent of radiating structures, and thus compete with one another for product volume (e.g., space with in the device). For these and other reasons, device manufacturers have had to either build devices that are large enough to include both the heat dissipating and radiating structures (e.g., personal computers, laptops, routers, etc.) or build smaller but less powerful devices (e.g., smartphones, IoT devices, etc.) that attempt to balance tradeoffs between performance and power consumption. Device manufacturers that opt to build the small and mid-sized devices often carve away sections of the heat dissipating structure (heatsinks) to make room for the radiating structures (antennas), or vice versa. The tradeoff or reduction in heat dissipation structure size for antenna installation reduces the thermal performance of the device because it decreases the surface area of the heat dissipating structure. This also degrades the radiation patterns on the radiating structures and may otherwise have a negative impact on the device's performance or reliability.

Some embodiments may include an integrated heatsink and antenna structure that is suitable for inclusion in small and midsized computing devices and which overcomes the above-described limitations of conventional solutions. The integrated heatsink and antenna structure may include heatsink portions and RF antenna portions. The heatsink portions may provide a path for dissipating thermal energy or heat generated by the components in the device (e.g., printed circuit boards, processors, voltage amplifiers, etc.), and the RF antenna portions may allow the device to send and receive wireless communications.

In some embodiments, the integrated heatsink and antenna structure may be formed so that RF antenna portions operate to improve the thermal performance of the heatsink portions and/or so that the heatsink portions operate to improve the antenna properties (e.g., radiation patterns, radiation efficiency, bandwidth, input impedance, polarization, directivity, gain, beam-width, voltage standing wave ratio, etc.) of the RF antenna portions. These improvements in thermal performance and/or antenna properties may allow device manufacturers to build more powerful small and midsized devices that provide robust functionality (e.g., via additional antennas, more powerful processors that generate more heat, etc.) and which may be formed into more visually appealing shapes.

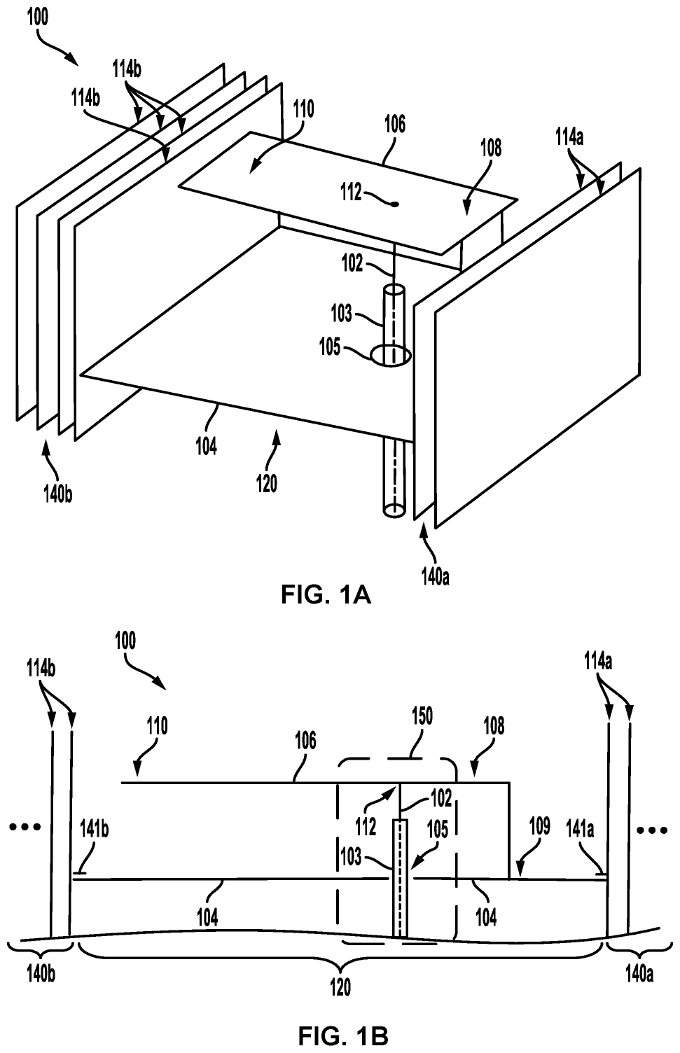

FIGS. 1A and 1B illustrate an antenna system 100 that could be included in a modular wireless communications system in accordance with some embodiments. The antenna system 100 may include a ground plane component 104, an antenna component (RF antenna portion 120 in the figures), and an integrated cable structure 150. The ground plane component 104 may include an aperture 150 through which the integrated cable structure 150 may be inserted or through which an elongated side of integrated cable structure 150 passes. The size of aperture 150 may be selected so that it is sufficiently large to allow heat or hot air to rise up through the aperture 105 alongside the sides, edges or surface of the integrated cable structure 150. The antenna component 120 may include a radiating portion 110, a grounded end 109, and a shorted portion 108. The antenna component 120 may also include an integrated cable structure 150 that includes a conductive element and a sheathing element (e.g., feed component 102 and sheeting 103 in the figures). The sheathing element (e.g., sheeting 103) may include nonconductive tubing and a conductive shielding. The conductive element may be included within the nonconductive tubing so that is it electrically isolated from the conductive shielding.

In particular, the antenna system 100 illustrated in FIGS. 1A and 1B includes an RF antenna portion 120 for sending and receiving wireless communications and heatsink portions 140a, 140b configured to dissipate thermal energy or heat. In addition, RF antenna portion may operate to improve the thermal performance of one or more of the heatsink portions 140a, 140b.

The RF antenna portion 120 may be (or may be plated with) aluminum, copper, stainless steel, beryllium copper, phosphor bronze or any other similar material or composition. The heatsink portions 140a, 140b may be (or may be plated with) aluminum, copper, or any other material or composition suitable for dissipating heat. For example, in an embodiment, the RF antenna portion 120 may be copper and the heatsink portions 140a, 140b may be aluminum.

The RF antenna portion 120 may include wideband, multiband, and/or ultrawideband (UWB) antennas. For example, the RF antenna portion 120 may be a patch antenna, inverted-L antenna, inverted-F antenna (e.g., planar inverted F-antenna (PIFA), dual frequency PIFA, etc.), or any other antenna suitable for wireless applications. In some embodiments, the RF antenna portion 120 and/or the antenna pattern may be selected based on heatsink characteristics (size, area, amount of heat metal, etc.).

In the examples illustrated in FIGS. 1A and 1B, the RF antenna portion 120 are formed as a planar inverted-F antenna. In particular, the RF antenna portion 120 may include a feed component 102, a ground plane component 104, and a radiating component 106. The radiating component 106 may have an L-shape, such that one leg of the L extends substantially parallel to and is offset from the ground plane component 104, while a second leg of the L (e.g., formed after a bend in the radiating component 106) extends substantially perpendicular to the first leg toward the ground plane component 104. In addition, one end of the second leg may be attached to or integrally formed with the ground plane component 104 at the grounded end 109.

In some embodiments (e.g., embodiments in which an RF antenna portion 120 is not formed as a planar inverted-F antenna, etc.), a monopole could be designed with the heat sink as ground reference. Further, some embodiments may include a ground plane independent primary radiator (e.g. dipole, etc.) that uses the heatsink as a field shaping structure (dish on a dish antenna).

Returning to examples illustrated in FIGS. 1A and 1B, the feed component 102 may be electrically coupled to a computing device (not illustrated), in which the antenna system 100 is included. Also, the feed component 102 may be fixedly secured (e.g., soldered, wire bonded) to the radiating component 106 at a feed point 112. In this way, the feed component 102 extends from the feed point 112, through an aperture 105 in the ground plane component 104, and to a physical connection with the computing device (e.g., to an RF device located on or communicatively coupled to a printed circuit board of the computing device). The feed component 102 may include or be associated with a casing or sheathing 103 that insulates the feed component 102. The feed point 112 may be disposed between a shorted portion 108 and a radiating portion 110 of the radiating component 106. The shorted portion 108 may extend away from the feed point 112, substantially parallel to the ground plane component 104 until the bend, beyond which the remainder of the shorted portion 108 extends toward the ground plane component 104 such that the grounded end 109 ends in contact with the ground plane component 104. In this way, the shorted portion 108 may be configured to electrically short one end of the radiating component 106 to the ground plane component 104. The radiating portion 110 may extend away from the feed point 112, in the opposite direction from the shorted portion 108, extending substantially parallel to the ground plane component 104, but include a remote end that is not attached to any other component or portion of the antenna system 100.

The location of the feed point 112 on the radiating component 106, dimensions of radiating portion 110, distance between the bend of the shorted portion 108, total contact area of the grounded end 109 with the ground plane component 104, and other various dimensions and physical characteristics of the RF antenna portion 120 can be designed and manufactured to tune the functionality of the RF antenna portion 120. For example, the location of the feed point 112 on the radiating component 106 can define an expected parasitic capacitance value observable between the length of the feed component 102 and the length of the parallel portion of the shorted portion 108, as well another expected parasitic capacitance value observable between the length of the radiating portion 110 and the ground plane component 104. A parasitic capacitance value observable between the end of radiating portion 110 and the vertical fin components 114b can also affect the RF operating parameters of the RF antenna portion 120. The RF antenna portion 120 can be designed to account for an expected parasitic capacitance value with respect to the vertical fun components 114b for tuning the operating parameters of the RF antenna portion 120.

The impedance of the RF antenna portion 120 can be controlled via the distance of the feed point 112 to the grounded end 109. Positioning the feed point 112 closer to the shorted end 108 can decrease the impedance of RF antenna portion 120, and positioning the feed point 112 farther from the shorted end 108 can increase the impedance of the RF antenna portion 120 comparatively. The RF antenna portion 120 can be designed to have the feed point 112 calculably located to define an impedance value that defines an operating frequency of the RF antenna portion 120 (e.g., 2.4 GHz, 5 GHz, broadband frequencies, etc.).

In various embodiments, the shorted portion 108 and the grounded end 109 can be wide (i.e., where a width of the grounded end 109 runs parallel to the vertical fin components 114a, 114b as illustrated by the example depicted in FIG. 1A) to provide structural support for the radiating component 106, and to provide increased surface area for dissipating heat. For example, the shorted portion 108 and the grounded end 109 can have a width close or equivalent to the width of the radiating portion 110. Using a wide portion of conductive material, as opposed to a thin film or a single wire, to form the shorted portion 108 and the grounded end 109 of the RF antenna portion 120 can allow for a single structure to be shaped to support the radiating component 106. For example, a single sheet of metal can be bent to form the radiating portion 110, the shorted portion 108, and the grounded end 109.

In various embodiments, the feed component 102 and the casing or sheathing 103 may be components of an integrated antenna coaxial cable structure, or other type of conductive cable structure having an inner conductor surrounded by a cylindrical tubing usable to isolate the inner conductor from external electrical signals. The integrated antenna coaxial cable structure may be passed through the aperture 105 and the feed component 102 and casing or sheathing 103 may be physically connected to the feed point 112 and the ground plane component 104 respectively to form separate electrical connections. The feed component 102 may be soldered to the feed point 112, and the casing or sheathing 103 may be soldered to the ground plane component 104.

In some examples, the integrated antenna coaxial cable structure may be coupled to the RF antenna portion 120 in a piecewise fashion. For example, the feed component 102 may not initially be disposed within the casing or sheathing 103, such that casing or sheathing 103 may be affixed to the ground plane component 104 before the feed component is inserted into the casing or sheathing 103. The casing or sheathing 103 can be inserted through the aperture 105 and can be affixed (e.g., soldered) to the ground plane component 104. Then, the feed component 102 can be inserted into the casing or sheathing 103 and electrically coupled (e.g., via a low-cost RF connector) to a printed circuit board of the computing device. The opposite end of the feed component 102 can then be affixed (e.g., soldered) to the feed point 112 to form an electrical connection from the printed circuit board to the radiating component 106, where the electrical connection is shielded by the casing or sheathing 103 electrically connected to ground. Connecting the feed component 102 to the feed point 112 and the casing or sheathing 103 to the ground plane component 104 can be performed in accordance with IPC-A 610 standards. The integrated antenna coaxial cable structure can improve heatsink performance and reduce manufacturing costs.

The heatsink portions 140a, 140b may each include vertical fin components 114a, 114b that provide thermal resistance and additional surface area for improved thermal performance. The first fin of heatsink portion 140b may provide capacitive tuning to the open end of the radio frequency patches (e.g., 2.4 GHz patches, etc.). This may allow the patches to be smaller than would be the case without the fin.

In various embodiments, the vertical fin components 114a, 114b may be (or may be plated with) aluminum, copper, or any other material or composition suitable for dissipating heat. In addition, the vertical fin components 114a, 114b may be formed of a material suitable for also enhancing one or more antenna properties (e.g., radiation patterns, radiation efficiency, bandwidth, input impedance, polarization, directivity, gain, beam-width, voltage standing wave ratio, etc.) of the RF antenna portion 120. A greater or fewer number of vertical fin components 114a, 114b may be included as part of the heatsink portions 140a, 140b (i.e., illustrated as ellipses on the outer right and left sides of FIG. 1B).

The ground plane component 104 may be coupled to one or more of the vertical fin components 114a, 114b and/or arranged to dissipate additional thermal energy and further improve thermal performance, similar to the vertical fin components 114a, 114b. For example, an innermost one of each of the vertical fin components 114a, 114b may include tabs 141a, 141b that hold the ground plane component 104 in place. Additional components may bias the ground plane component 104 into contact with the tabs 141a, 141b, thus securing (i.e., holding) the RF antenna portion 120 and the heatsink portions 140a, 140b together. Alternatively, a clip or slot may be provided on or in the innermost ones of the vertical fin components 114a, 114b for securing the ground plane component 104 to the vertical fin components 114a, 114b. In this way, securing the ground plane component 104 to the vertical fin components 114a, 114b couples the RF antenna portion 120 to the heatsink portions 140a, 140b. Also, this coupling may produce a synergistic effect of providing an RF antenna portion 120 that improves the thermal performance of the heatsink portions 140a, 140b, as well as heatsink portions 140a, 140b that improve the antenna properties of the RF antenna portion 120.

The computing device, in which the antenna system 100 is included, may dissipate the same amount of heat and/or achieve the same thermal performance as conventional devices that have larger structures that include larger or a greater number of fin components that occupy more area. In accordance with various embodiments, the antenna system 100 may be packaged into a smaller or more compact container and/or to include additional or more powerful components (e.g., additional antennas, more powerful processors that generate more heat, etc.) than conventional devices.

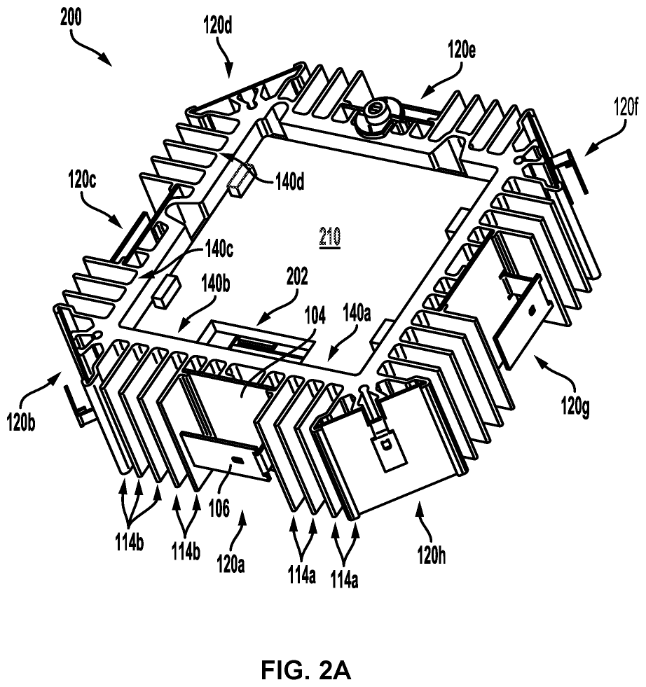

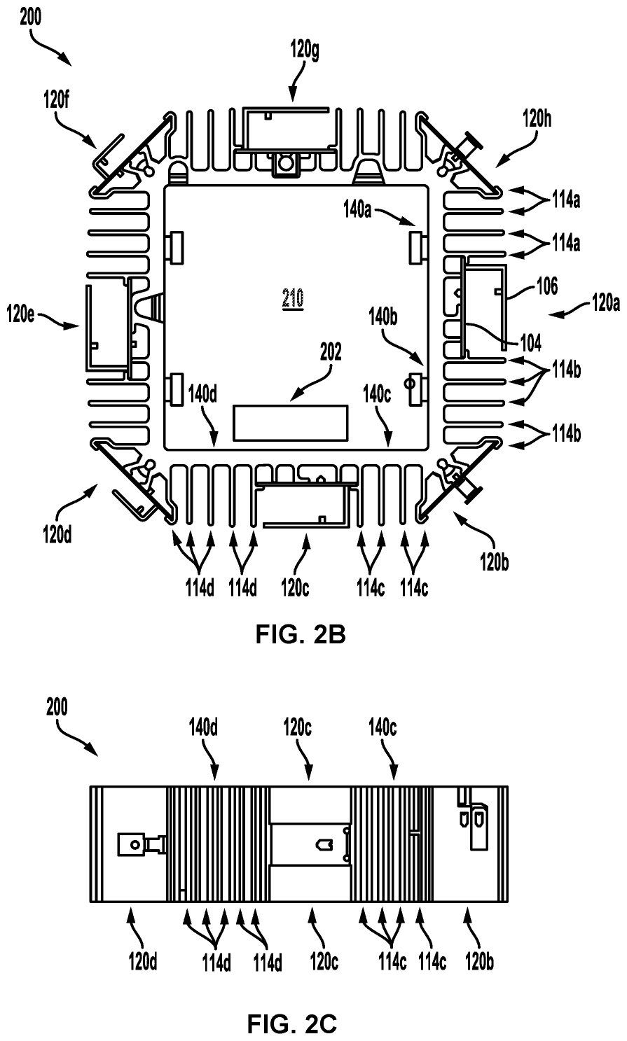

FIGS. 2A-2C illustrate an integrated heatsink and antenna structure 200 that includes multiple sets of the antenna system 100 described above with regard to FIG. 1, in accordance with some embodiments. The integrated heatsink and antenna structure 200 may include numerous antennas. The location that the RF antenna is located or the amount of RF antennas used is for illustrative purposes to demonstrate the novel idea.

In the illustrated examples, the integrated heatsink and antenna structure 200 includes eight (8) RF antenna portions 120a-h coupled to a heatsink base component 210. The heatsink base component 210 may improve the omnidirectional pattern of the antenna portions (120a-h).

Each of the RF antenna portions 120a-h may be coupled to and surrounded by fin components (e.g., 114a-d) integrated into the heatsink base component 210 and that dissipate thermal energy. For example, four (4) of the RF antenna portions 120a, 120c, 120e, 120g may be disposed on the sides of the integrated heatsink and antenna structure 200, each having a similar configuration to that described with regard to antenna system 100 in FIGS. 1A and 1B. In contrast, four (4) more of the RF antenna portions 120b, 120d, 120f, 120h may be disposed on the corners of the integrated heatsink and antenna structure 200, each flanked by sets of fin components (e.g., 114b, 114c), but those flanking fin components may be disposed on two different sides of the integrated heatsink and antenna structure 200.

The integrated heatsink and antenna structure 200 may include a cavity onto which a processor, computing system, printed circuit board, integrated circuit (IC) chips, a system on chip (SOC), or system in a package (SIP) and/or other similar components may be implemented or placed. In some embodiments, the integrated heatsink and antenna structure 200 may include a connector port 202 that provides an interface between components of the integrated heatsink and antenna structure 200 and other computers or peripheral devices.

In some embodiments, the components/chips may be placed on a heat conducting material (not illustrated separately in FIGS. 2A-C) that is placed on top of the cavity (or aluminum housing) to help with the heat transfer and to address any imperfections that arise during manufacturing.

In some embodiments, the integrated heatsink and antenna structure 200 may dissipate heat or Watts/mm² (or Watts/inch²) from the chip to the integrated heatsink and antenna structure 200, from the integrated heatsink and antenna structure 200 to ambient air, and/or from the chip to ambient air.

As mentioned above, the integrated heatsink and antenna structure 200 may include multiple RF antennas 120a-h. The RF antennas 120a-h may include wideband, multiband, and/or ultrawideband (UWB) antennas. For example, the RF antennas 120a-h may include patch antennas, inverted-L antennas, inverted-F antennas (e.g., PIFA, dual frequency PIFA, etc.) or any other antenna suitable for wireless applications. In some embodiments, the RF antennas 120a-h and/or the antenna pattern may be selected based on heatsink characteristics (size, area, amount of heat metal, etc.).

As mentioned above, securing the ground plane component 104 to the vertical fin components 114a, 114b couples the RF antenna portions 120 to the heatsink portion. In the various embodiments, the ground plane for any of the RF antenna portions 120 may be changed so that it is potentially smaller than shown in the figures, but running the entire length behind the heatsink fin components 114.

In some embodiments, the heatsink fin components 114 may be arraigned into a fin structure that is slightly different for each RF antenna portion 120a-h or for each antenna location. In some embodiments, each of the RF antenna portions 120 may be tuned for frequency band and/or modified based on frequency, bandwidth, impedance, proximity to the heatsink fin components 114 and/or the corresponding fin structure.

In various embodiments, the antenna and heatsink portions may be fabricated, manufactured, or otherwise constructed as separate distinct components of the integrated heatsink and antenna structure 200. For example, the heatsink base component 210 may be fabricated and/or constructed via a first process (e.g., a diecast or extruded process), and the RF antenna portions 120a-h may be fabricated or constructed via a different process (e.g., a folding and/or stamp metal process). The RF antenna portions 120a-h may be affixed to the heatsink base component 210 at ground plane component 104 by any process including soldering, welding, clamping, stamping, crimping, or any other suitable means for forming a stable metal-to-metal connection. This allows for the application of various different RF antenna portions 120a-h having different physical dimensions with corresponding RF characteristics (e.g., impedance value 36.4 Ohms, 50 Ohms, etc.) while using the same heatsink base component 210 design in each embodiment. By separating the construction of the RF antenna portions 120a-h and the heatsink base component 210, various levels of precision may be used in the manufacturing of the RF antenna portions 120a-h depending on the desired application. For example, a cheaper and faster manufacturing process may be used to fabricate the RF antenna portions 120a-h in applications with minimal requirements as compared to applications requiring a high level of precision (e.g., broadcasting at precise voltage levels within a specific frequency range). The heatsink base component 210 can then be combined with any variety of RF antenna portions 120a-h to form the integrated antenna and heatsink and antenna structure 200. As previously mentioned, the integrated antenna coaxial cable structure comprising a feed element and a casing or sheathing may also be manufactured separately and installed after the RF antenna portions 120a-h are coupled to the heatsink base component 210.

The orientation of the vertical fin components 114a, 114b of the heatsink base component 210 can facilitate vertical motion of air along the length of the vertical fin components 114a, 114b, allowing heat to rise as the heatsink base structure radiates infrared heat outwards through the vertical fin components 114a, 114b. As previously described, the radiating portion 110, shorted portion 108, and grounded end 109 (not labeled in FIG. 2A-C) can have a width as determined by the design and manufacturing process for each application. In a similar fashion as the vertical fin components 114a, 114b, the radiating portion 110, shorted portion 108, and grounded end 109 can be affixed to the ground plane component 104 to facilitate the vertical flow of air and heat dissipation. A greater width of any of the radiating portion 110, shorted portion 108, and grounded end 109 can increase the total surface area through which heat can dissipate Thus, the radiating portion 110 can act as a heat dispensing element while also functioning as an RF broadcasting element, such that heat from the ground plane component 104 can be indirectly transferred to the radiating portion 110 through the grounded end 109 and shorted portion 108.

In various embodiments, the heatsink base component 210 having heatsink portions 140a, 140b comprising vertical fin components 114a, 114b can be manufactured to adjust the length of the vertical fin components proximate to ground plane component 104. As illustrated in FIG. 2B, vertical fin components positioned between the heatsink base component 210 and the ground plane component 104 are a shorter length than the vertical fin components 114a, 114b to provide room for the radiating portion 110. For example, the vertical fin components positioned between the heatsink base component 210 and the ground plane component 104 may be 5 millimeters (0.19685 inches) and the vertical fin components 114a, 114b may be 15 millimeters (0.590551 inches). Adjusting the length of these shorter vertical fin components to provide for more or less heat dissipation can have a direct impact of the parasitic capacitance defined by the distance between the radiating portion 110 to the ground plane component 104. Thus, dimensions of the radiating portion 110 and the distance between the radiating portion 110 to the ground plane component 104 can be designed based upon an anticipated parasitic capacitance value.

At lower operating frequencies (e.g., 2.4 GHz), parasitic capacitance may be less consequential in terms of design dimensions of the radiating portion 110 than at higher operating frequencies (e.g., 5 GHz). Lower operating frequencies can allow for less restrictive design parameters, and may ignore or give less importance to a high parasitic capacitance value. For example, a parasitic capacitance value may increase as the distance between the radiating portion 110 and the ground plane component 104 decreases. Reducing the designed distance between the radiating portion 110 and the ground plane component 104 can allow for more space within the heatsink base component 210 design, such that the vertical fin components positioned between the heatsink base component 210 and the ground plane component 104 can be extended to increase total system heat dissipation. For example, the shorter vertical fin components can be extended to 10 millimeters (0.393701 inches) and the ground plane component 104 and radiating portion 110 can be designed to fit within the remaining 5 millimeters of a 15-millimeter layout. Thus, dimensions of the vertical fin components between the ground plane components and the heatsink base component 210 may affect the dimensions of the radiating portion 110 during design. Increasing the length of the vertical fin components may increase the parasitic capacitance applied at the radiating portion 110 that therefore should be considered when designing the dimensions of the radiating portion 110, depending on the intended operating frequencies. Similarly, higher operating frequencies, where parasitic capacitance may be more detrimental to signal quality, may implement designs that increases the distance between the radiating portion 110 and the ground plane component 104, which may affect the total allowable length of the vertical fin components proximate to the ground plane component 104. The length of the vertical fin components proximate to each ground plane component on each side of the heatsink base component 210 can be similarly adjusted.

A parasitic capacitance value observable between the end of radiating portion 110 and the vertical fin components 114b can also affect the RF operating parameters of the RF antenna portion 120 (e.g., at high frequencies). The RF antenna portion 120 can be designed to account for an expected parasitic capacitance value with respect to the vertical fun components 114b for tuning the operating parameters of the RF antenna portion 120. For example, the radiating portion 110 can be constructed using a material having a specific impedance value based on an expected parasitic capacitance between the radiating portion 110 and the vertical fin components 114b. In some embodiments, the physical dimensions of the radiating portion 110 may be designed to tune the RF antenna portion 120. For example, a width of the end of radiating portion 110 proximate to the vertical fin components 114b may be adjusted or designed based on an anticipated parasitic capacitance value. The length of the radiating portion 110 can be designed to define the distance between the radiating portion 110 and the vertical fin components 114b.

In various embodiments, the distance between the end of the radiating portion 110 and the vertical fin components 114b can be increased or decreased to adjust an anticipated or actual parasitic capacitance value, and therefore adjust the operating parameters of the RF antenna portion 120. Adjusting the distance between the end of the radiating portion 110 and the vertical fin components 114b to tune the RF antenna portion 120 can be implemented during design or after fabrication (i.e., in-field) of the RF antenna portion 120. For example, the RF antenna portion 120 may be malleable (e.g., at the grounded end 109 and the bend between grounded end 109 and shorted portion 108), shiftable, or slottable (e.g., reattachable at various slots connecting ground plane component 104 to grounded end 109) to adjust the distance between the radiating portion 110 and the vertical fin components 114b. This may be useful when implementing the RF antenna portion at various frequencies for different RF applications, especially for high frequency operations in which parasitic capacitance may affect the operating parameters of the RF antenna portion 120 more than lower frequency operations.

In a manner similar to adjusting the dimensions of the radiating portion 110 based on the length of the vertical fin components proximate to the ground plane component 104, and vice versa, the length of the ground plane component 104 and radiating portion 110 can be adjusted to allow for an increased or reduced number of vertical fin components 114a, 114b. For example, adjusting the length of the ground plane component 104 and the radiating portion 110 to produce specific operating parameters can cause less space and therefore fewer implementable vertical fin components 114a, 114b. Alternatively, the dimensions of the ground plane component 104 and radiating portion 110 may be adjusted to accommodate for an increased need for additional vertical fin components 114a, 114b.

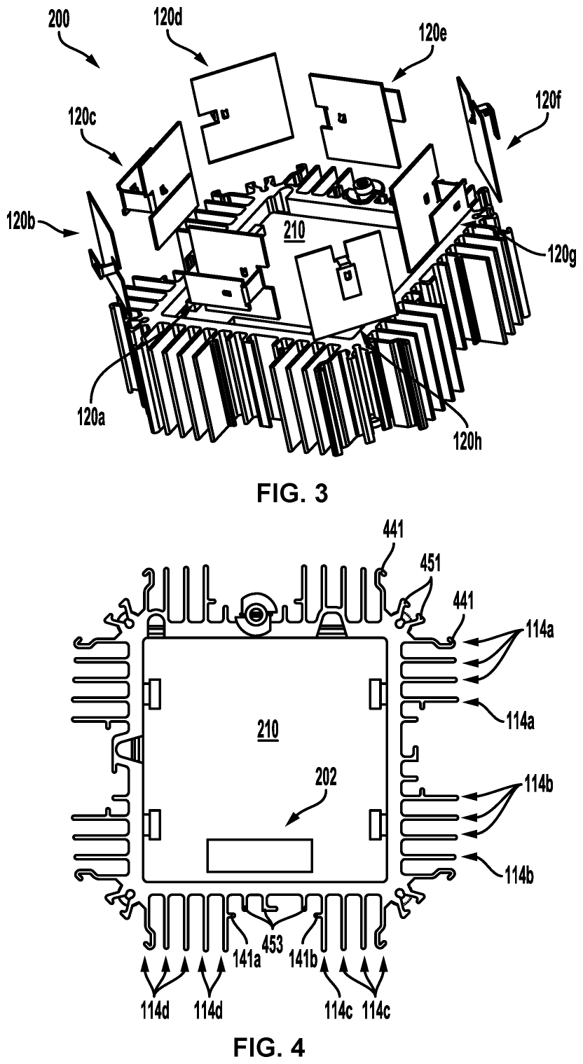

FIG. 3 illustrates a partially exploded view of the integrated heatsink and antenna structure 200. As shown, the RF antenna portions 120a-h may be separated from and/or attached to the heatsink base component 210 using securing structures incorporated into some of the fin components.

In some embodiment, the antenna elements/portions may be formed curved of a springy material. The heat sink features may hold the antenna elements/portions flat so that so friction (primarily) holds them in place. As such, the RF antenna portions 120a-h may be attached to the heatsink base component 210 via a friction fit. In addition, the integrated heatsink and antenna structure 200 may be formed to fit into a plastic housing (not illustrated separately in FIG. 3) that has features that ensure location of the radiating element so that the antennas do not become detuned by having the structure bent out of shape.

FIG. 4 illustrates the heatsink base component 210 in accordance with various embodiments. In particular, FIG. 4. shows some of the retaining structures that may be incorporated into some of the fin components for holding and retaining the RF antenna portions (e.g., 120a-h). For example, the corner fin components may have hooked ends 441 such that the hooked ends 441 on a pair of opposed corner fin components may bend toward one another. The hooked ends 441 may be used to trap an RF antenna portion. The RF antenna portion may also be supported by corner mini-fins 451 that project out toward the RF antenna portion. In this way, each of the RF antenna portions on the corners of the heatsink base component 210 may be trapped between a pair of the hooked ends 441 and a set of the corner mini-fins 451. Similarly, the RF antenna portions on the sides of the heatsink base component 210 may be trapped between a pair of the tabs 141a, 141b and a set of additional mini-fins 453.

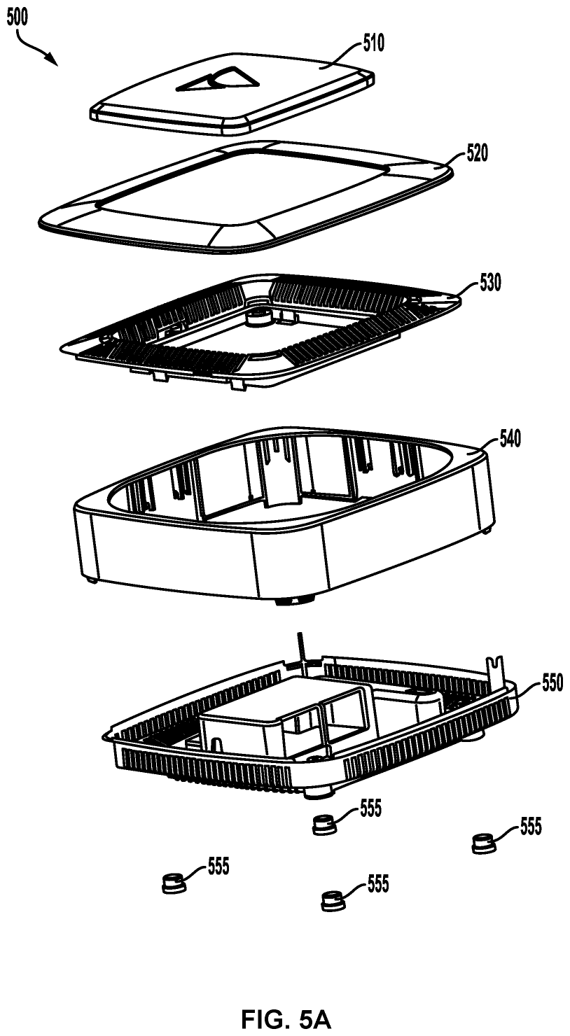

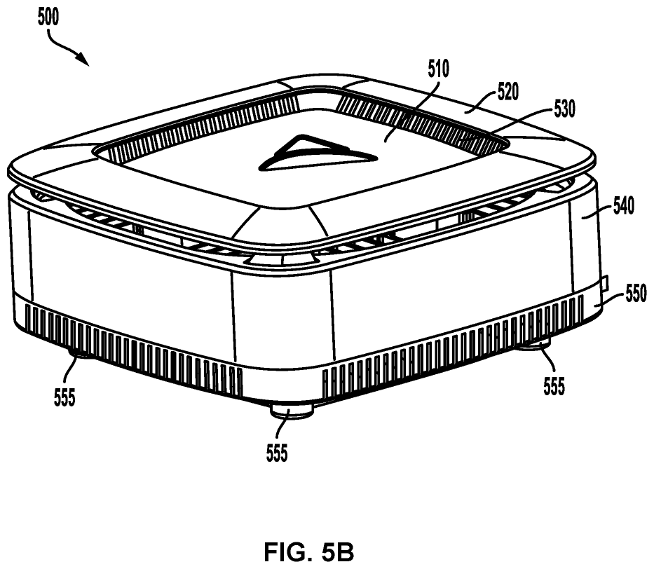

FIGS. 5A and 5B illustrate a stackable housing 500 for an integrated heatsink and antenna structure in accordance with some embodiments. The stackable housing 500 may include a lid 510, an upper rim 520, an upper tray 530, a housing casing 540, housing base 550, and housing feet 555. In accordance with various embodiments, the integrated heatsink and antenna structure (e.g., integrated heatsink and antenna 200 illustrated in FIG. 2A, etc.) may be seated on top of the housing base 550. Once the integrated heatsink and antenna structure 200 is mounted on the housing base 550, the housing casing 540 may be slipped over and surround the integrated heatsink and antenna structure 200. The lid 510, upper rim 520, and upper tray 530 may then close off the assembly by being secured on top of the housing casing 540. Additional components and/or circuitry may be located between the integrated heatsink and antenna structure and the housing base 550. Similarly, components and/or circuitry may be located between the lid 510 and the upper tray 530.

In various embodiments, the stackable housing 500 may be stacked on top of, on the side of, or below another stackable housing 500, which then allows multiple integrated heatsink and antenna structures (e.g., 200) to be used together in a compact arrangement. To stack the stackable housings 500, the lid 510, upper rim 520, and upper tray 530 of all but the uppermost stackable housing 500 may be removed so as to expose one integrated heatsink and antenna structure below to another integrated heatsink and antenna structure above. For example, two of the stackable housings shown in FIGS. 5A and 5B may stacked on top of and couple to one another in accordance with some embodiments.

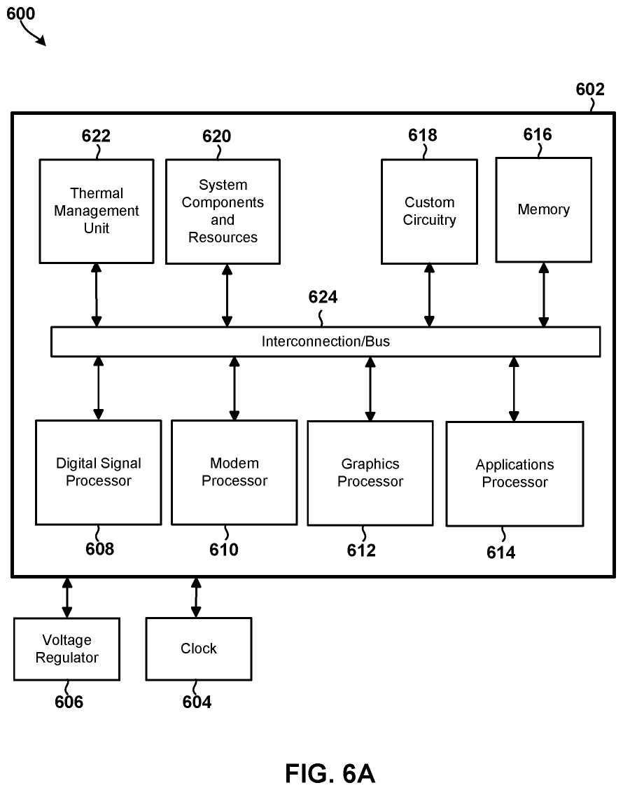

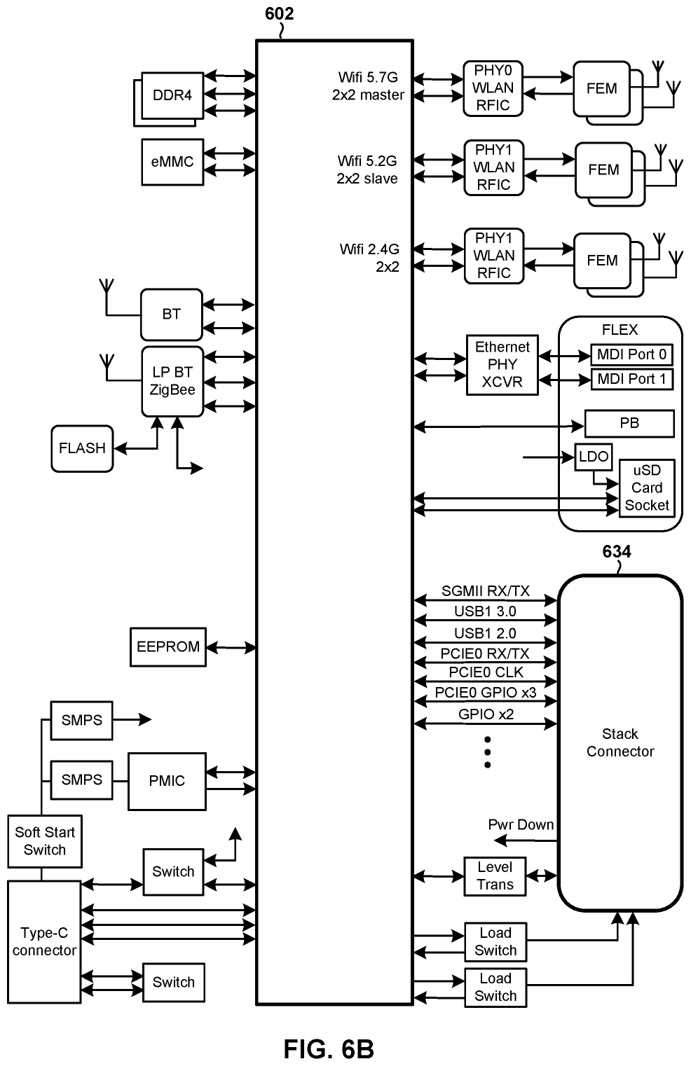

FIGS. 6A and 6B illustrates an example computing system 600 that may be used with integrated heatsink and antenna structure 200 in accordance with some embodiments. In the example illustrated in FIG. 6, the computing system 600 includes an SOC 602, a clock 604, and a voltage regulator 606.

In overview, an SOC may be a single IC chip that contains multiple resources and/or processors integrated on a single substrate. A single SOC may contain circuitry for digital, analog, mixed-signal, and radio-frequency functions. A single SOC may also include any number of general purpose and/or specialized processors (packet processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices. The components in an SOC may generate a significant amount of thermal energy or heat, and thus the placement of the components within the SOC, the location of the SOC within the integrated heatsink and antenna structure 200, and other thermal management considerations are often important.

With reference to FIG. 6A, the SOC 602 may include a digital signal processor (DSP) 608, a modem processor 610, a graphics processor 612, an application processor 614 connected to one or more of the processors, memory 616, custom circuitry 618, system components and resources 620, a thermal management unit 622, and an interconnection/bus module 624. The SOC 602 may operate as central processing unit (CPU) that carries out the instructions of software application programs by performing the arithmetic, logical, control and input/output (I/O) operations specified by the instructions.

The thermal management unit 622 may be configured to monitor and manage the device's junction temperature, surface/skin temperatures and/or the ongoing consumption of power by the active components that generate thermal energy in the device. The thermal management unit 622 may determine whether to throttle the performance of active processing components (e.g., CPU, GPU, LCD brightness), the processors that should be throttled, the level to which the frequency of the processors should be throttled, when the throttling should occur, etc.

The system components and resources 620 and custom circuitry 618 may manage sensor data, analog-to-digital conversions, wireless data transmissions, and perform other specialized operations, such as decoding data packets and processing video signals. For example, the system components and resources 620 may include power amplifiers, voltage regulators, oscillators, phase-locked loops, peripheral bridges, temperature sensors (e.g., thermally sensitive resistors, negative temperature coefficient (NTC) thermistors, resistance temperature detectors (RTDs), thermocouples, etc.), semiconductor-based sensors, data controllers, memory controllers, system controllers, access ports, timers, and other similar components used to support the processors and software clients running on a device. The custom circuitry 618 may also include circuitry to interface with other computing systems and peripheral devices, such as wireless communication devices, external memory chips, etc.

Each processor 608, 610, 612, 614 may include one or more cores, and each processor/core may perform operations independent of the other processors/cores. For example, the SOC 602 may include a processor that executes a first type of operating system (e.g., FreeBSD, LINUX, OS X, etc.) and a processor that executes a second type of operating system (e.g., MICROSOFT WINDOWS 10). In addition, any or all of the processors 608, 610, 612, 614 may be included as part of a processor cluster architecture (e.g., a synchronous processor cluster architecture, an asynchronous or heterogeneous processor cluster architecture, etc.).

The processors 608, 610, 612, 614 may be interconnected to one another and to the memory 618, system components and resources 620, and custom circuitry 618, and the thermal management unit 622 via the interconnection/bus module 624. The interconnection/bus module 624 may include an array of reconfigurable logic gates and/or implement a bus architecture (e.g., CoreConnect, AMBA, etc.). Communications may be provided by advanced interconnects, such as high-performance networks-on chip (NoCs).

The SOC 602 may further include an input/output module (not illustrated) for communicating with resources external to the SOC, such as the clock 604 and the voltage regulator 606. Resources external to the SOC (e.g., clock 604, etc.) may be shared by two or more of the internal SOC processors/cores.

In addition to the SOC 602 discussed above, the various embodiments may include or may be implemented in a wide variety of computing systems, which may include a single processor, multiple processors, multicore processors, or any combination thereof.

With reference to FIG. 6B, the computing system 600 may include a stack connector 634, which may correspond to and/or may be used in conjunction with the connector port 202 illustrated in FIGS. 2A, 2B, and 4. The stack connector 634 may include interconnection/bus module with various data and control lines for communicating with the SOC 602. The stack connector 634 may also expose systems buses and resources of a SOC 602 or computing device 600 in a manner that allows the chip or computing system to attach to an additional unit to include additional features, functions or capabilities, but which preserves the performance and integrity of the original SOC 602 or computing device 600.

The processors may be any programmable microprocessor, microcomputer or multiple processor chip or chips that can be configured by software instructions (applications) to perform a variety of functions, including the functions of the various aspects described in this application. In some wireless devices, multiple processors may be provided, such as one processor dedicated to wireless communication functions and one processor dedicated to running other applications. Typically, software applications may be stored in the internal memory 906 before they are accessed and loaded into the processor. The processor may include internal memory sufficient to store the application software instructions.

As used in this application, the terms “component,” “module,” “system,” and the like may refer to a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect. For example, one or more of the operations of the methods may be substituted for or combined with one or more operations of the methods.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. An antenna system for use in a modular wireless communications system, the antenna system comprising:
a ground plane component; and
an antenna component comprising:
a radiating portion for broadcasting wireless communications signals;
a grounded end affixable to the ground plane component; and
a shorted portion positioned between the radiating portion and the grounded end.

2. The antenna system of claim 1, further comprising:
an integrated cable structure comprising:
a conductive element; and
a sheathing element including a nonconductive tubing surrounded by a conductive shielding, wherein the conductive element is positionable within the nonconductive tubing to be electrically isolated from the conductive shielding.

3. The antenna system of claim 2, wherein the ground plane component includes an aperture through which an elongated side of integrated cable structure is inserted.

4. The antenna system of claim 3, wherein the size of aperture of the ground plane component is sufficiently large to allow heat or hot air to rise through the aperture alongside the inserted integrated cable structure.

5. The antenna system of claim 2, wherein a first end of the conductive element is affixable to a tuning point of the antenna component, the tuning point being positionable between the radiating portion and the shorted portion, and a second end of the conductive element is affixable to a radio frequency (RF) transceiver.

6. The antenna system of claim 5, wherein the conductive element is useable to send and receive wireless communications between the radiating portion and the RF transceiver, wherein the RF transceiver is in electric communication with a computing device configurable to process RF data.

7. The antenna system of claim 5, wherein the tuning point is determinable based on a desired impedance value of the antenna component that is defined by the distance between the radiating portion and the ground plane component.

8. The antenna system of claim 2, wherein the conductive shielding of the sheathing element is affixable to the ground plane component.

9. The antenna system of claim 2, wherein the integrated cable structure is a coaxial cable.

10. The antenna system of claim 1, wherein the antenna component is a planar inverted F-antenna (PIFA).

11. The antenna system of claim 1, wherein the radiating portion, the shorted portion, and the grounded end are formable from a single piece of material.

12. The antenna system of claim 1, wherein the grounded end is affixed along a surface of the ground plane component to provide structural support sufficient to keep the radiating portion stationary.

13. The antenna system of claim 1, wherein the antenna component is operable to dissipate heat transferred from the ground plane component.

14. The antenna system of claim 1, wherein the modular wireless communications system comprises:
the antenna system; and
a heatsink base comprising:
a frame structure; and
a plurality of fin components projecting outwardly from the frame structure, wherein a portion of the plurality of fin components are configured to receive and hold the antenna system.

15. The antenna system of claim 14, wherein the antenna system is oriented with respect to the plurality of fin components, such that a first direction of airflow travelling between the plurality of fin components is the same or substantially the same as a second direction of airflow travelling around the antenna system.

16. The antenna system of claim 14, wherein operating parameters of the antenna component are based at least in part on a parasitic capacitance value between the radiating portion and the plurality of fin components, wherein the parasitic capacitance value is based at least in part on the distance between the radiating portion and the plurality of fin components.

17. A wireless modular communications system comprising:
an antenna system comprising:
a ground plane component; and
an antenna component comprising:
a radiating portion for broadcasting wireless communications signals;
a grounded end affixable to the ground plane component; and
a shorted portion positioned between the radiating portion and the grounded end; and
an integrated cable structure comprising:
a conductive element; and
a sheathing element including a nonconductive tubing surrounded by a conductive shielding, wherein the conductive element is positionable within the nonconductive tubing to be electrically isolated from the conductive shielding;
wherein the integrated cable structure is insertable into an aperture of the ground plane component, and
wherein a first end of the conductive element is affixable to a tuning point of the antenna component, the tuning point being positionable between the radiating portion and the shorted portion, and a second end of the conductive element is affixable to a radio frequency (RF) transceiver; and
a heatsink base comprising:
a frame structure; and
a plurality of fin components projecting outwardly from the frame structure, wherein a portion of the plurality of fin components are configured to receive and hold the antenna system.

18. A computing device, comprising
a processor; and
an antenna system coupled to the processor, the antenna system comprising:
a ground plane component; and
an antenna component comprising:
a radiating portion for broadcasting wireless communications signals;
a grounded end affixable to the ground plane component; and
a shorted portion positioned between the radiating portion and the grounded end.

19. The computing device of claim 18, wherein the antenna system further comprises an integrated cable structure comprising:
a conductive element; and
a sheathing element including a nonconductive tubing surrounded by a conductive shielding, wherein the conductive element is positionable within the nonconductive tubing to be electrically isolated from the conductive shielding.

20. The computing device of claim 19, wherein the ground plane component includes an aperture through which an elongated side of integrated cable structure is inserted.
